(19) United States
(12) Patent Application Publication
(10) Pub. No.: US 2009/0228305 A1
(43) Pub. Date: Sep. 10, 2009

(54) METHOD FOR PROVIDING SERVICES AVAILABLE WITHIN A NEIGHBORHOOD

(76) Inventors: Goran Gustafsson, Tyreso (SE); Johan Backman, Sigtuna (SE)

Correspondence Address: FASTH LAW OFFICES (ROLF FASTH), 26 PINECREST PLAZA, SUITE 2, SOUTHERN PINES, NC, 28387-4301, US

(21) Appl. No.: 11/573,414

(22) PCT Filed: Aug. 4, 2005
(86) PCT No.: PCT/US05/27588

§ 371 Date: Feb. 8, 2007

Related U.S. Application Data
(60) Provisional application No. 60/600,418, filed on Aug. 10, 2004.

(51) Int. Cl. G06Q 30/00; G06Q 40/00; G06Q 50/00; G06F 17/30

(52) U.S. Cl. 705/4; 705/14; 705/26; 707/5; 707/E17.017

(57) ABSTRACT

The method is for providing a service system. The method identifies a location of a user of the service system. The user selects a category of the service system. A database is searched for service providers of the selected category. The method identifies a first location of a first service provider and a second location of a second service provider found in the search for the selected category. The first location is closer to the location of the user than the second location. The first and second service providers are ranked regarding proximity to the location of the user so that the first service provider is ranked higher and listed before the second service provider. A map is provided showing the location of the user, the first location of the first service provider and the second location of the second service provider.

### TECHNICAL FIELD

The present invention relates to a method for identifying services that are available within a neighborhood or in close proximity of the user.

### BACKGROUND OF THE INVENTION

It is becoming more common to require services for the home such as services related to performing everyday household related to the home and family. For example, the services may relate to childcare, house, car maintenance or any other thing that a homeowner of family member would typically need to do but may not have the time or inclination carry out. Very often it is difficult for the homeowner or family member to know whom in the neighborhood is able and willing to carry out some of those tasks. Because the services required are sometimes low paying, it is not worth for the service provider to travel great distance to carry out the service so it is most convenient to have somebody in the neighborhood perform the tasks. Today there is currently no efficient and simple way to find out whom in the neighborhood can carry out which services.

There is a need for a service that in one place effectively identifies services that are available within a neighborhood, provided both by private persons and enterprises. There is also a need for service providers to effectively reach potential consumers within the neighborhood.

### SUMMARY OF THE INVENTION

The method of the present invention provides a solution to the above-outlined problems. More particularly, the method is for providing a service system. The method identifies a location of a user of the service system. The user selects a category of the service system. A database is searched for service providers of the selected category. The method identifies a first location of a first service provider and a second location of a second service provider found in the search for the selected category. The first location is closer to the location of the user than the second location. The first and second service providers are ranked regarding proximity to the location of the user so that the first service provider is ranked higher and listed before the second service provider. A map is provided showing the location of the user, the first location of the first service provider and the second location of the second service provider. In this way, the user and the service provider can connect in an effective way.

### BRIEF DESCRIPTION OF THE DRAWING

FIG. 1 is a schematic view of a search display of the present invention;

FIG. 2 is a schematic view of a result display of the present invention;

FIG. 3 is a schematic view of a detailed description of a person from the result display in FIG. 2.

FIG. 4 is a schematic view of a registration flow;

FIG. 5 is a schematic view of a log-in procedure; and

FIG. 6 is a schematic view of a personal page.

### DETAILED DESCRIPTION

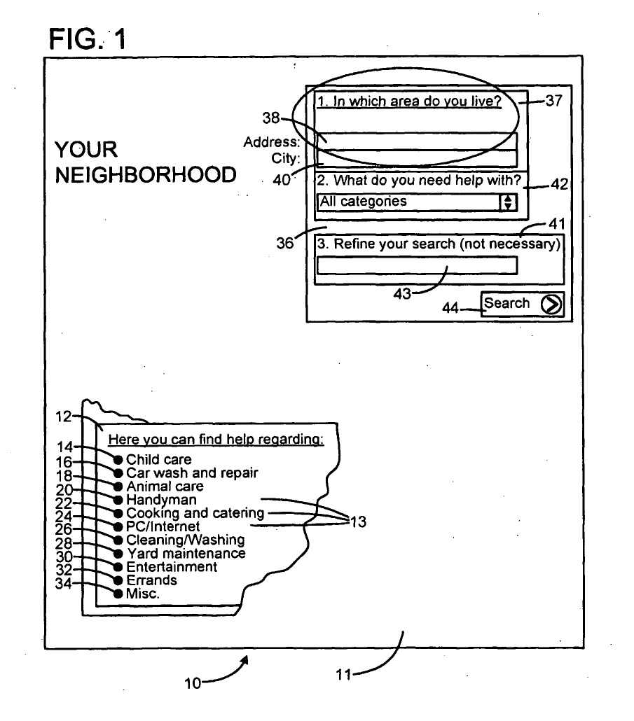

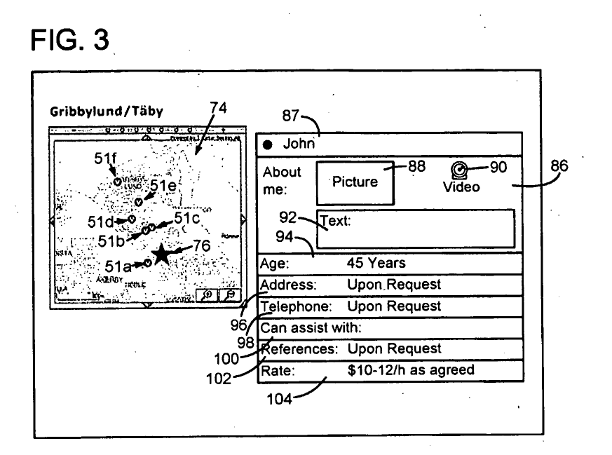

With reference to FIGS. 1-3, the service system 10 of the present invention has a display 11 including a list 12 of categories 13 such as child care 14, carwash and repair 16, animal care 18, handyman 20, cooking and catering 22, PC/Internet 24, cleaning/washing 26, yard-maintenance 28, entertainment 30, errands 32 and miscellaneous 34. It is to be understood that the above categories can change and are only used as illustrative examples to show the principles of the method of the present invention.

The display 11 also has a search segment 36 that requests the user to specify the user's location 37 by adding a street address of the user in a first box 38 and/or the name of a city or town in a second box 40. The user is also asked to specify which category 13 is of interest as shown in a category-selecting scroll down list 42. It is also possible to not make a choice and then all categories are presented. If needed, the user may refine the search within a category by activating an optional refined search box 41 by adding an additional search word 43 such as painting windows in order to only identify service providers that have specified painting windows as being part of the service provided. The user may then start the search by activating a search command 44 so that a search of service providers in the user's neighborhood is performed. The search is focused on finding service provided in the category selected by the user and who are in close proximity of the user's location as indicated in the boxes 38, 40.

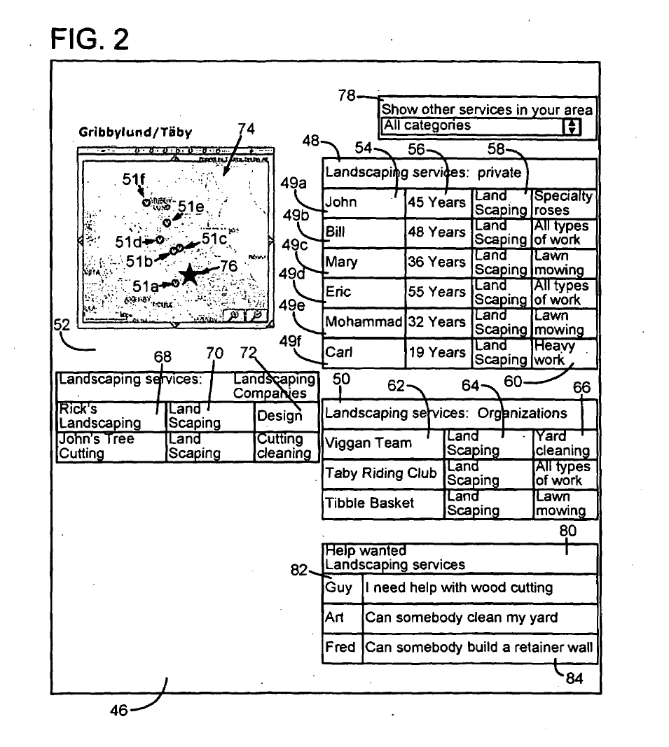

As best shown in FIG. 2, a result display 46 is then shown to the user. The display 46 shows the result of the search conducted when the search command 44 is activated. The display 46 may include a first result list 48 that lists private persons 49a-49f who are willing to perform the service in the category requested. The list 48 may include columns related to name 54, age 56, service category 58 and comments 60 into which special comments may be added that in more detail describe the services provided by the private person 49a-49f. The display may also include a second result list 50 that lists organizations and a third result list 52 that lists service companies in the neighborhood or region. The list 50 may include name 62, category 64 and comments 66 that describe the services provided in more detail. Similarly, the list 52 may include name 68, category 70 and comments 72 that describe the services provide in more detail. Of course, the lists may be modified to include other or different information as desired.

Another important feature of the present invention is that the display 46 includes a map 74 that is synchronized with the lists shown such as the lists 48, 50, and 52. The map shows the location 76 of the user, according to the information provided in the boxes 38, 40, and the location of the persons/organizations/companies listed in the lists 48, 50, 52, respectively. For example, the map 74 may show the locations 51a-51f of the private persons 49a-49f, respectively, so that the user can easily see where the private persons found in the search live. An important feature of the present invention is that the private persons 49a-49f can be listed according to proximity to the user's location 76 so that the closest private person is given the highest ranking and is listed first. If the user's location is unknown the service providers within the area may be listed in a random order. It may also be possible to rank the service providers based on how much they have paid to the service system provider 10. It may also be possible for the user to change the ranking of the service providers.

All the private persons 49a-49f, organizations 62 and companies 68 may be required to pay a fee to the service system provider of the service system 10.

Additional lists for other categories 13 may be displayed by changing the category in a category-selecting list 78. The display 46 may also show a help-wanted display 80. The display 80 may show categories related to name 82 and comment 84 where the person seeking help may specify what the requested help is about. The buyers of the services may register and receive newsletters, tax information and other useful information about the services and the service providers. The sellers responding to the help-wanted display may click on the name 82 to receive more information about the selected person who needs help.

By clicking on the one of the private persons 49a-49f of the list 48, such as the person 49d, a more detailed display 86 about the person 49d is shown. The display 86 may include name 87, picture 88, video 90, brief description 92, age 94, address 96, telephone number 98, service provided 100, references 102 and charge rate 104. The private person may elect not to display the address, telephone number and references in the display 86. In this case, the user may later be provided with this information either from the private person in question or from the service system provider of the service system 10. All service providers must register with the provider of the service system 10 when the payment is made. It may also be possible to charge the user at other stages in the process of using the system 10. The provider of the service system 10 may assist the registered service providers with fliers to give good continuity of the marketing in the neighborhood.

The segment name 87 may be linked to the name column 54 of the display 48 and the age segment 94 may be linked to the column 56 of the display 48. The display 86 may be displayed while the map 74 is shown on the screen. The brief description 92 may be linked to the search words 43 in the refined search box 41.

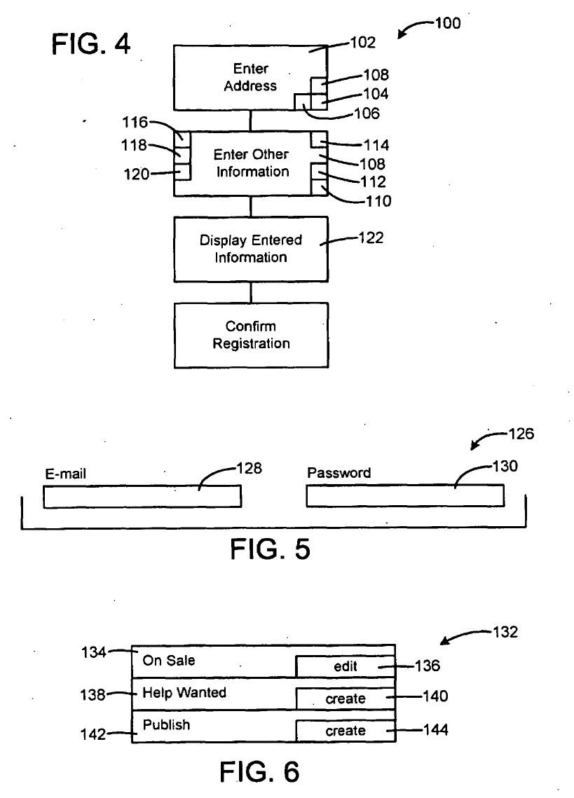

FIG. 4 is a schematic view of a registration process 100. In a first step 102 an address 104 is entered to decide the geographical location of the advertisement. Based on the address 104 entered a search is made in an address-database 106 and coordinates of the address is stored.

In a second step 108, all other information 110 is entered. A map 112 shows as a confirmation the entered address. The advertiser can, if it is a private advertisement, select if the street address will be shown in the advertisement. There is also a possibility of uploading a photo/logo 114. The information entered may include personal information such as name, address, telephone numbers, mail-address etc. For company advertisements and for organizations/school classes, this section may also contain fields 116 for company name, organizational number etc. There may be fields for personal description/company description 118 and for references. There may be a display 120 where there is an opportunity to enter a description and price for each of the services offered. There is also a possibility to only show the information for the service provider's member organization. In a third step 122, the entered information is displayed to enable the advertiser to confirm the correctness. In a fourth step 124, the registration is finalized and an automated e-mail is sent to the advertiser to confirm the registration. The e-mail contains all the entered information including login-information such as user-id and password,

FIG. 5 is a schematic view of a log-in page 126 that includes an email field 128 and a password field 130. The service provider may enter user-id and password to access the user's personal pages. These pages may also be tied to a membership of an organization and thereby additional information. It is also possible for a user (that is not a service provider) to login to its member organization.

FIG. 6 is a schematic view of a personal page 132. There is an on sale field 134 that may be edited by activated an editing command 136. There is a help wanted field 138 with a create field 140. Also, there is a publish field 142 and a create field 144. On the personal page, the user can find statistics on number of hits on advertisements etc. and has the possibility of changing existing ads or registering other types of ads under the same user-id. If the user is logged in to a certain member organization, there is additional information about the organization and a possibility to also see advertisements for members only. For certain members of an organization it is also possible to publish information for the organization.

It should be noted that the registration and log-in pages may be reached from the main page. The most recent advertisement may show on the main page and be activated by clicking on the advertisement.

It is also possible to provide a liability insurance to service providers of the system of the present invention. This liability insurance takes care of certain situations when private service providers are delivering services and today are not insured if something goes wrong. The service providers have the option of buying the insurance. It is also possible for the system provider to insure certain group of service providers as part of the service provided.

It is also possible to provide a customized system to an organization, such as a real estate and neighborhood organizations, so that certain information is only shown to members of the organization. The neighborhood organization can provide news and other information to the members on the website of the customized system. The customized system may use a special payment schedule so that organization is responsible for payment to the system provider. The payment to the system provider may reduce the price of using the system by the members of the organization to make it more attractive to use the services provided in the customized system.

While the present invention has been described in accordance with preferred compositions and embodiments, it is to be understood that certain substitutions and alterations may be made thereto without departing from the spirit and scope of the following claims.

1. A method of providing a service system, comprising:
identifying a location of a user of the service system;
selecting a category of the service system required by the user;
searching a data base for service providers of the selected category;
identifying a first location of a first service provider and a second location of a second service provider found in the search for the selected category, the first location being closer to the location of the user than the second location; and
ranking the first and second service providers regarding proximity to the location of the user so that the first service provider is ranked higher and listed before the second service provider.

2. The method according to claim 1 wherein the method further comprises providing a map showing the location of the user, the first location of the first service provider and the second location of the second service provider.

3. The method according to claim 1 wherein the method further comprises providing lists of private service providers, companies and organizations and help-wanted advertisements, and displaying a detailed display about a selected service provider.

4. The method according to claim 1 wherein the method further comprises a registration flow where the service providers put in relevant information for the users of a service system

5. A method of providing a service system, comprising:
providing services by service providers consisting of private service providers, and companies;
requiring the private service providers, and companies to register and provide contact information and special skills related to a category;
selecting a category of the service system required by the user;
searching a database for available service providers in the selected category;
displaying available service providers in the selected category; and
a user creating a help-wanted advertisement when the service requested is not available among the service providers

6. The method according to claim 5 wherein the method further comprises service providers that are organizations.

7. The method according to claim 5 wherein the method further comprises service providers that are school classes.

8. The method according to claim 5 wherein the method further comprises providing a map showing the location of the selected service providers and sorting the selected service providers based on a distance to the user.

9. The method according to claim 5 wherein the method further comprises providing a liability insurance to the registered private service providers that applies to the delivery of services.

10. The method according to claim 5 wherein the method further comprises creating a customized system to a member organization so that certain information is only shown to members of the member organization, the member organization paying the system provider and lowering a price of using the system by the members of the member organization.
